(19) United States
(12) Patent Application Publication
(10) Pub. No.: US 2025/0201928 A1
(43) Pub. Date: Jun. 19, 2025

(54) LIQUID ELECTROLYTE FOR LITHIUM METAL BATTERIES

(71) Applicant: SYENSQO SA, Brussels (BE)

(72) Inventors: Ji-Ae Choi, Goyang-si (KR); Moon-Hyung Choi, Seoul (KR); So-Young Lee, Seoul (KR); Jong-Hyun Lee, Hwaseong-si (KR); Seung-Gi Hwang, Seoul (KR)

(73) Assignee: SYENSQO SA, Brussels (BE)

(21) Appl. No.: 18/843,994

(22) PCT Filed: Feb. 24, 2023
(86) PCT No.: PCT/EP2023/054733

§ 371 Date: Sep. 4, 2024

(30) Foreign Application Priority Data
Mar. 10, 2022 (EP) 22161264.1

(51) Int. Cl. H01M 10/0569; H01M 4/02; H01M 4/525; H01M 10/0525; H01M 10/0567; H01M 10/0568; H01M 50/414

(52) U.S. Cl. CPC H01M 10/0569; H01M 4/525; H01M 10/0525; H01M 10/0567; H01M 10/0568; H01M 50/414; H01M 2004/028; H01M 2300/0034; H01M 2300/0037

(57) ABSTRACT

The present invention relates to a liquid electrolyte for lithium metal batteries, comprising a) at least one fluorinated di-ether containing from 4 to 10 carbon atoms, represented by Formula (I) of R¹—O—R²—O—R³, wherein each R¹ and R³ is independently a fluorinated alkyl group, and R² is an optionally fluorinated alkyl group; b) at least one non-fluorinated ether; c) at least one lithium salt; and d) a lithium hexafluorophosphate (LiPF₆) in an amount of 5% by weight (wt %) or less, preferably 3 wt % or less, and more preferably 1 wt % or less, based on the total weight of the liquid electrolyte, wherein a) the fluorinated di-ether is in an amount of at least 50% by volume (vol %), based on the total volume of a) the fluorinated di-ether and b) the non-fluorinated ether; and c) the lithium salt is different from d) LiPF₆. The present invention also relates to a lithium metal battery comprising an anode comprising lithium metal; a cathode; a separator; and a liquid electrolyte according to the present invention.

### CROSS-REFERENCE TO RELATED APPLICATION

This application claims priority to European patent application No. 22161264.1 filed on Mar. 10, 2022, the whole content of this application being incorporated herein by reference for all purposes.

### TECHNICAL FIELD

The present invention relates to a liquid electrolyte for lithium metal batteries, comprising a) at least one fluorinated di-ether containing from 4 to 10 carbon atoms, represented by Formula I of R¹—O—R²—O—R³, wherein each R¹ and R³ is independently a fluorinated alkyl group, and R² is an optionally fluorinated alkyl group; b) at least one non-fluorinated ether; c) at least one lithium salt; and d) a lithium hexafluorophosphate (LiPF₆) in an amount of 5% by weight (wt %) or less, preferably 3 wt % or less, and more preferably 1 wt % or less, based on the total weight of the liquid electrolyte, wherein a) the fluorinated di-ether is in an amount of at least 50% by volume (vol %), based on the total volume of a) the fluorinated di-ether and b) the non-fluorinated ether; and c) the lithium salt is different from d) LiPF₆. The present invention also relates to a lithium metal battery comprising an anode comprising lithium metal, a cathode, a separator, and a liquid electrolyte according to the present invention.

### BACKGROUND OF THE INVENTION

Lithium ion batteries have retained a dominant position in the market of rechargeable energy storage devices thanks to their many benefits such as light-weight, reasonable energy density, and good cycle life. Nevertheless, current lithium ion batteries still suffer from relatively low energy density with respect to the required energy density, which continuously increases to meet the needs for high power applications such as electrical vehicles, hybrid electrical vehicles, grid energy storage (aka large-scale energy storage), etc.

Employing lithium metal as anode has been known since the 1970s, thanks to the favourable characteristics of lithium metal resulting from its low redox potential and high specific capacity. Such a lithium metal battery usually uses conventional liquid electrolytes such as a carbonate-based electrolyte and/or an ether-based electrolyte having a low viscosity and a high ionic conductivity. However, these liquid electrolytes easily decompose to make a passivation layer at the beginning of the cycles, which eventually results in the dendrite growth, and also further side reactions between the electrolyte and the deposited reactive lithium ions. These have been the critical issues impeding the commercialization of lithium metal batteries.

The basic requirements of a suitable electrolyte for lithium metal batteries are the same as conventional liquid electrolytes for lithium ion batteries, i.e, high ionic conductivity, low melting and high boiling points, (electro)chemical stability and also safety. In addition to said basic requirements, the suitable electrolyte for lithium metal batteries should provide solutions to the drawbacks as above mentioned.

Use of a solid electrolyte instead of a liquid electrolyte has been considered as a solution to reduce or suppress the lithium dendrite formation and to improve the cycling performance of the lithium metal batteries. For example R. Sudo et al. describe in Solid State Ionics, 262, 151 (2014) the use of Al-doped Li₇La₃Zr₂Oi₂ as a solid electrolyte in an electrochemical cell comprising a Li metal as negative electrode.

D. Aurbach et al. in Solid State Ionics, 148, 405 (2002) and H. Ota et al. in Electrochimica Acta, 49, 565 (2004) report that additives such as CO₂, SO₂, and vinylene carbonate help in improving the stability of the passivation layer.

Despite such efforts, the appearance of lithium dendrites were still observed and said additives were consumed during the operation of the cell so that use of additives could not provide a long-term solution against the dendrite formation.

Other various approaches with the same purpose have been made via modification of the liquid electrolyte, for instance, by using a liquid electrolyte with a high lithium salt concentration in dimethoxyethane (DME)-1,3dioxolane (DOL) (1:1 v:v) for suppressing lithium dendrite formation [L. Suo et al. in Nature Communications, DOI:10.1038/ncomms2513 (2013)]; and by applying a solvated ionic liquid of tetraglyme (G4) and LiFSI as the electrolyte [H. Wang et al. report in ChemElectroChem, 2, 1144 (2015)].

WO 2015/078791 A1 (Solvay Specialty Polymers Italy S.P.A.) discloses an electrolyte formulation comprising a hydrofluoroether as an essential component of the electrolyte mixture and also a polar organic solvent, notably organic carbonates.

In particular, EP3118917 B1 (Samsung Electronics Co., Ltd.) discloses an electrolyte for a lithium metal battery, comprising a non-fluorine substituted ether capable of solvating lithium ions, a fluorine substituted ether, which is a glyme-based solvent with a particular formula, and a lithium salt, wherein the amount of the fluorine substituted ether is greater than an amount of the non-fluorine substituted ether.

In addition, WO 2021/213743 (Solvay SA) discloses an anode-less lithium ion battery comprising a liquid electrolyte composition comprising at least one fluorinated ether, at least one non-fluorinated ether, and at least one lithium salt.

There still exists, however, the outstanding needs to provide an electrolyte for a lithium metal battery having more improved cell performance including safety, while minimizing the dendrite growth and the side reactions between the liquid electrolyte and the anode.

### SUMMARY OF THE INVENTION

The present invention relates to a liquid electrolyte for lithium metal batteries, comprising:
a) at least one fluorinated di-ether containing from 4 to 10 carbon atoms, represented by Formula I

R¹—O—R²—O—R³ (Formula I)
wherein each R¹ and R³ is independently a fluorinated alkyl group, and R² is an optionally fluorinated alkyl group;
b) at least one non-fluorinated ether;
c) at least one lithium salt; and
d) a lithium hexafluorophosphate (LiPF₆) in an amount of 5% by weight (wt %) or less, preferably 3 wt % or less, and more preferably 1 wt % or less, based on the total weight of the liquid electrolyte,
wherein a) the fluorinated di-ether is in an amount of at least 50% by volume (vol %), based on the total volume of a) the fluorinated di-ether and b) the non-fluorinated ether; and c) at least one lithium salt is different from d) LiPF₆.

The present invention also relates to a lithium metal battery comprising an anode comprising lithium metal, a cathode, a separator, and a liquid electrolyte according to the present invention.

It was surprisingly found by the inventors that the above-mentioned technical problems can be solved by using a liquid electrolyte for lithium metal batteries according to the present invention, which is evidenced by excellent capacity retention. In particular, the inventors found that the incorporation of LiPF₆ in addition to c) the lithum salt contributes to the improvement of the cycle retention. It is believed that LiPF₆ incorporated into the liquid electrolyte in addition to c) the lithum salt, which is different from LiPF₆, supports the formation of a more resistive solid electrolyte interface (SEI) layer and makes the initial discharge capacity decrease.

### BRIEF DESCRIPTION OF DRAWINGS

FIG. 1 shows cycle retention (%) of LiCoO₂/Li cells with liquid electrolytes of E1 and CE1-CE3 at 3.0-4.4V (0.5C/0.5C).

### DETAILED DESCRIPTION OF THE INVENTION

### Definitions

Throughout this specification, unless the context requires otherwise, the word “comprise” or “include”, or variations such as “comprises”, “comprising”, “includes”, including” will be understood to imply the inclusion of a stated element or method step or group of elements or method steps, but not the exclusion of any other element or method step or group of elements or method steps. According to preferred embodiments, the word “comprise” and “include”, and their variations mean “consist exclusively of”.

As used in this specification, the singular forms “a”, “an” and “the” include plural aspects unless the context clearly dictates otherwise. The term “and/or” includes the meanings “and”, “or” and also all the other possible combinations of the elements connected to this term.

The term “between” should be understood as being inclusive of the limits.

As used herein, “alkyl” groups include saturated hydrocarbons having one or more carbon atoms, including straight-chain alkyl groups, such as methyl, ethyl, propyl, butyl, pentyl, hexyl, heptyl, octyl, nonyl, decyl, cyclic alkyl groups (or “cycloalkyl” or “alicyclic” or “carbocyclic” groups), such as cyclopropyl, cyclopentyl, cyclohexyl, cycloheptyl, and cyclooctyl, branched-chain alkyl groups, such as isopropyl, tert-butyl, sec-butyl, and isobutyl, and alkyl-substituted alkyl groups, such as alkyl-substituted cycloalkyl groups and cycloalkyl-substituted alkyl groups.

The term “aliphatic group” includes organic moieties characterized by straight or branched-chains, typically having between 1 and 18 carbon atoms. In complex structures, the chains may be branched, bridged, or cross-linked. Aliphatic groups include alkyl groups, alkenyl groups, and alkynyl groups.

As used herein, the terminology “(Cₙ-Cₘ)” in reference to an organic group, wherein n and m are integers, respectively, indicates that the group may contain from n carbon atoms to m carbon atoms per group.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example.

Unless otherwise specified, in the context of the present invention the amount of a component in a composition is indicated as the ratio between the volume of the component and the total volume of the composition multiplied by 100, i.e. % by volume (vol %) or as the ratio between the weight of the component and the total weight of the composition multiplied by 100, i.e. % by weight (wt %).

The constituents of the lithium metal battery comprising an anode comprising lithium metal; a cathode, a separator and a liquid electrolyte according to the present invention are described hereinafter in details. It is to be understood that both the foregoing general description and the following detailed description are exemplary and are intended to provide further explanation of the invention as claimed. Accordingly, various changes and modifications described herein will be apparent to those skilled in the art. Moreover, descriptions of well-known functions and constructions may be omitted for clarity and conciseness.

The present invention relates to a liquid electrolyte for lithium metal batteries, comprising:
a) at least one fluorinated di-ether containing from 4 to 10 carbon atoms, represented by Formula I

R¹—O—R²—O—R³ (Formula I)
wherein each R¹ and R³ is independently a fluorinated alkyl group, and R² is an optionally fluorinated alkyl group;
b) at least one non-fluorinated ether;
c) at least one lithium salt; and
d) a lithium hexafluorophosphate (LiPF₆) in an amount of 5 wt % or less, preferably 3 wt % or less, and more preferably 1 wt % or less, based on the total weight of the liquid electrolyte,
wherein a) the fluorinated di-ether is in an amount of at least 50% by volume (vol %), based on the total volume of a) the fluorinated di-ether and b) the non-fluorinated ether; and c) at least one lithium salt is different from d) LiPF₆.

In one embodiment, a) the fluorinated di-ether contains from 5 to 8 carbon atoms.

In another embodiment, a) the fluorinated di-ether contains 8 carbon atoms.

In the another embodiment, a) the fluorinated di-ether contains 7 carbon atoms.

In a preferred embodiment, a) the fluorinated di-ether contains 6 carbon atoms.

In one embodiment, the molar ratio F/H in a) the fluorinated di-ether is from 1.3 to 13.0, preferably from 2.5 to 6.0.

In one embodiment, a) the fluorinated di-ether is acyclic.

In the present invention, the term “fluorinated ayclic di-ether” is intended to denote an acyclic di-ether compound, wherein at least one hydrogen atom is replaced by fluorine. One, two, three or a higher number of hydrogen atoms may be replaced by fluorine.

In the present invention, the term “boiling point” is intended to denote the temperature at which the vapour pressure of a liquid substance equals to the pressure surrounding the liquid and the liquid changes its physical status into a vapour. The boiling point of a liquid substance varies depending on the surrounding environmental pressure and the boiling point according to the invention corresponds to the boiling point when the liquid is at atmospheric pressure, aka the atmospheric boiling point.

In one embodiment, the boiling point of a) the fluorinated di-ether is at least 80° C., preferably from 80° C. to 160° C., and more preferably from 100° C. to 160° C.

In one embodiment, the liquid electrolyte according to the present invention comprises
from 60 to 90 vol % of at least one fluorinated di-ether compound; and
from 10 to 40 vol % of at least one non-fluorinated ether compound, with respect to the total volume of the fluorinated di-ether and the non-fluorinated ether.

In another embodiment, the liquid electrolyte according to the present invention comprises
from 80 to 90 vol % of at least one fluorinated di-ether compound; and
from 10 to 20 vol % of at least one non-fluorinated ether compound, with respect to the total volume of the fluorinated di-ether and the non-fluorinated ether.

Non-limitative examples of suitable a) fluorinated di-ether according to the present invention include, notably, the followings:
CF₃CH₂—O—CF₂CHF—O—CF₃, CHF₂CH₂—O—CF₂CF₂—O—CF₃, CF₃CF₂—O—CHFCHF—O—CHF₂, CHF₂CF₂—O—CHFCHF—O—CF₃, CF₃CHF—O—CHFCF₂—O—CHF₂, CF₃CHF—O—CF₂CHF—O—CHF₂, CH₃CF₂—O—CF₂—O—CF₂CF₃, CFH₂CHF—O—CF₂—O—CF₂CF₃, CF₃CF₂—O—CHF—O—CHFCHF₂, CF₃CF₂—O—CHF—O—CHFCHF₂, CF₃CH₂—O—CF₂CF₂—O—CF₃, CHF₂CHF—O—CF₂CF₂—O—CF₃, CH₂FCF₂—O—CF₂CF₂—O—CF₃, CF₃CF₂—O—CHFCHF—O—CF₃, CF₃CF₂—O—CF₂CH₂—O—CF₃, CF₃CF₂—O—CH₂CF₂—O—CF₃, CF₃CF₂—O—CF₂CFH—O—CHF₂, CF₃CHF—O—CHFCF₂—O—CF₃, CF₃CHF—O—CF₂CHF—O—CF₃, CHF₂CF₂—O—CF₂CHF—O—CF₃, CHF₂CF₂—O—CHFCF₂—O—CF₃, CHF₂CF₂—O—CF₂CF₂—O—CHF₂, CF₃CHF—O—CF₂CF₂—O—CHF₂, CF₃CF₂—O—CF₂—O—CHFCF₃, CF₂HCF₂—O—CF₂—O—CF₂CF₃, CF₃CHF—O—CF₂—O—CF₂CF₃, CF₃CF₂—O—CHF—O—CF₂CF₃, CF₃CF₂—O—CF₂—O—CF₂CHF₂, CF₂HCF₂—O—CF₂CH₂—O—CF₂CF₂H, CF₃CF₂—O—CH₂CH₂—O—CF₂CF₃, CF₂HCF₂—O—CHFCHF—O—CF₂CF₂H, CF₃CF₂—O—CHFCH₂—O—CF₂CF₂H, CF₃CF₂—O—CH₂CHF—O—CF₂CF₂H, CF₃—O—CHFCF₂CH₂—O—CF₂CF₂H, CF₂HCF₂—O—CF₂CF₂—O—CF₂CF₂H, CF₃CF₂—O—CF₂CHF—O—CF₂CF₂H, CF₃CF₂—O—CHFCF₂—O—CF₂CF₂H, CF₃CF₂—O—CF₂CH₂—O—CF₂CF₃, CF₃CF₂—O—CHFCHF—O—CF₂CF₃, CF₂HCF₂—O—CH₂CH₂—O—CF₂CF₂H, CF₂HCF₂—O—CF₂CHF—O—CF₂CF₂H, and mixtures thereof.

In one embodiment, a) the fluorinated di-ether comprises CF₂HCF₂—O—CF₂CH₂—O—CF₂CF₂H, CF₃CF₂—O—CH₂CH₂—O—CF₂CF₃, CF₂HCF₂—O—CHFCHF—O—CF₂CF₂H, CF₃CF₂—O—CHFCH₂—O—CF₂CF₂H, CF₃CF₂—O—CH₂CHF—O—CF₂CF₂H, CF₂HCF₂—O—CF₂CF₂—O—CF₂CF₂H, CF₃CF₂—O—CF₂CHF—O—CF₂CF₂H, CF₃CF₂—O—CHFCF₂—O—CF₂CF₂H, CF₃CF₂—O—CF₂CH₂—O—CF₂CF₃, CF₃CF₂—O—CHFCHF—O—CF₂CF₃, CF₂HCF₂—O—CH₂CH₂—O—CF₂CF₂H, CF₂HCF₂—O—CF₂CHF—O—CF₂CF₂H, and mixtures thereof.

In a preferred embodiment, a) the fluorinated di-ether comprises CF₂HCF₂—O—CH₂CH₂—O—CF₂CF₂H, CF₂HCF₂—O—CHFCHF—O—CF₂CF₂H, CF₂HCF₂—O—CF₂CHF—O—CF₂CF₂H, and mixtures thereof.

In a more preferred embodiment, a) the fluorinated di-ether is CF₂HCF₂—O—CH₂CH₂—O—CF₂CF₂H.

In the present invention, the term “non-fluorinated ether” is intended to denote an ether compound, wherein no fluorine atom is present.

Non-limitative examples of suitable b) non-fluorinated ether according to the present invention include, notably, the followings:
aliphatic, cycloaliphatic or aromatic ether, more particularly, dibutyl ether, dipentyl ether, diisopentyl ether, dimethoxyethane (DME), 1,3-dioxolane (DOL), tetrahydrofuran (THF), 2-methyltetrahydrofuran, and diphenyl ether;
glycol ethers, such as ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monomethyl ether, diethylene glycol monoethyl ether, diethylene glycol mono-n-butyl ether, ethylene glycol dimethyl ether, diethylene glycol dimethyl ether (DEGME), ethylene glycol diethyl ether, diethylene glycol diethyl ether (DEGDEE), tetraethylene glycol dimethyl ether (TEGME), polyethylene glycol dimethyl ether (PEGDME); and
glycol ether esters, such as ethylene glycol methyl ether acetate, ethylene glycol monoethyl ether acetate, ethylene glycol monobutyl ether acetate.

In a preferred embodiment, b) the non-fluorinated ether according to the present invention comprises dimethoxyethane (DME), 1,3-dioxolane (DOL), dibutyl ether, tetraethylene glycol dimethyl ether (TEGME), diethylene glycol dimethyl ether (DEGME), diethylene glycol diethyl ether (DEGDEE), polyethylene glycol dimethyl ether (PEGDME), 2-methyltetrahydrofuran, and tetrahydrofuran (THF).

In a more preferred embodiment, b) the non-fluorinated ether is a mixture of DME and DOL.

In another more preferred embodiment, b) the non-fluorinated ether is DME.

Non-limitative examples of c) the lithium salt according to the present invention include, notably, the followings:
a lithium ion complex such as lithium perchlorate (LiClO₄), lithium hexafluoroarsenate (LiAsF₆), lithium hexafluoroantimonate (LiSbF₆), lithium hexafluorotantalate (LiTaF₆), lithium tetrachloroaluminate (LiAlCl₄), lithium tetrafluoroborate (LiBF₄), lithium chloroborate (Li₂B₁₀Cl₁₀), lithium fluoroborate (Li₂B₁₀F₁₀), Li₂B₁₂FₓH₁₂₋ₓ wherein x=0-12, LiPFₓ(R_{F})₆₋ₓ and LiBF_{y}(R_{F})_{4-y} wherein R_{F} represents perfluorinated C₁-C₂₀ alkyl groups or perfluorinated aromatic groups, x=0-5 and y=0-3, lithium bis(oxalato)borate [LiB(C₂O₄)₂], lithium bis(malonato)borate [LiB(O₂CCH₂CO₂)₂], lithium bis(difluoromalonato) borate [LiB(O₂CCF₂CO₂)₂], LiPF₂[O₂C(CX₂)ₙCO₂]₂, LiPF₄[O₂C(CX₂)ₙCO₂] wherein X is selected from the group consisting of H, F, Cl, C₁-C₄ alkyl groups and fluorinated alkyl groups, and n=0-4, lithium trifluoromethane sulfonate (LiCF₃SO₃), lithium bis(fluorosulfonyl)imide Li(FSO₂)₂N (LiFSI), LiN(SO₂CₘF₂ₘ₊₁)(SO₂CₙF₂ₙ₊₁) and LiC(SO₂CₖF₂ₖ₊₁)(SO₂CₘF₂ₘ₊₁)(SO₂CₙF₂ₙ₊₁) wherein k=1-10, m=1-10 and n=1-10, LiN(SO₂CₚF₂ₚSO₂) and LiC(SO₂CₚF₂ₚSO₂)(SO₂C_{q}F_{2q+1}) wherein p=1-10 and q=1-10, and mixtures thereof.

In one embodiment, c) the lithium salt according to the present invention is selected from the group consisting of lithium perchlorate (LiClO₄), lithium hexafluoroarsenate (LiAsF₆), lithium hexafluoroantimonate (LiSbF₆), lithium hexafluorotantalate (LiTaF₆), lithium tetrachloroaluminate (LiAlCl₄), lithium tetrafluoroborate (LiBF₄), lithium chloroborate (Li₂B₁₀Cl₁₀), lithium fluoroborate (Li₂B₁₀F₁₀), Li₂B₁₂FₓH₁₂₋ₓ wherein x=0-12, LiPFₓ(R_{F})₆₋ₓ and LiBF_{y}(R_{F})_{4-y} wherein R_{F} represents perfluorinated C₁-C₂₀ alkyl groups or perfluorinated aromatic groups, x=0-5 and y=0-3, lithium trifluoromethane sulfonate (LiCF₃SO₃), lithium bis(fluorosulfonyl)imide Li(FSO₂)₂N (LiFSI), LiN(SO₂CₘF₂ₘ₊₁)(SO₂CₙF₂ₙ₊₁) and LiC(SO₂CₖF₂ₖ₊₁)(SO₂CₘF₂ₘ₊₁)(SO₂CₙF₂ₙ₊₁) wherein k=1-10, m=1-10 and n=1-10, LiN(SO₂CₚF₂ₚSO₂) and LiC(SO₂CₚF₂ₚSO₂)(SO₂C_{q}F_{2q+1}) wherein p=1-10 and q=1-10, and mixtures thereof.

In the present invention, d) the lithium salt is different from LiPF₆.

In one embodiment, d) the lithium salt is lithium bis(trifluoromethanesulfonyl) imide (LiN(CF₃SO₂)₂) (LiTFSI).

In another embodiment, d) the lithium salt is LiFSI.

In one embodiment, a molar concentration (M) of the lithium salt in the liquid electrolyte according to the present invention is from 0.5 M to 8 M, preferably from 0.7 M to 3 M, and more preferably from 1 M to 2 M.

The liquid electrolyte according to the present invention comprises d) a lithium hexafluorophosphate (LiPF₆) in an amount of 5 wt % or less, preferably 3 wt % or less, and more preferably 1 wt % or less, based on the total weight of the liquid electrolyte.

The present inventors found that by incorporating d) LiPF₆ in an amount of 5 wt % or less in addition to c) the lithum salt, the cycle retention can be improved. It is believed that d) LiPF₆ incorporated into the liquid electrolyte in addition to c) the lithum salt, which is different from LiPF₆, contributes to the decrease of initial discharge capacity and also to the formation of a more resistive solid electrolyte interface (SEI) layer on the surface of the electrodes.

According to one embodiment, the liquid electrolyte according to the present invention further comprises e) at least one film-forming additive, which promotes the formation of the SEI layer at the anode surface by reacting in advance of the solvents on the anode surface. For the SEI layer, the main components hence comprise the decomposed products of liquid electrolyte and salts, which may include Li₂CO₃ (in case of LiCoO₂ as a cathode electro-active material), lithium alkyl carbonate, lithium alkyl oxide and other salt moieties such as LiF.

In the present invention, e) the film-forming additive is different from c) the lithium salt and from d) LiPF₆.

According to another embodiment, e) the film-forming additive stabilizes the cathode electrolyte interface (CEI) layer at the cathode surface by preventing the structural change of the cathode, notably under high voltage.

This is because the reduction potential of e) the film-forming additive is higher than that of the liquid electrolyte when a reaction occurs at the anode surface, and the oxidation potential of the film-forming additive is lower than that of the liquid electrolyte when the reaction occurs at the cathode side.

In one embodiment, e) the film-forming additive according to the present invention is selected from the group consisting of cyclic sulfite and sulfate compounds comprising 1,3-propanesultone (PS), ethylene sulfite (ES) and prop-1-ene-1,3-sultone (PES); sulfone derivatives comprising dimethyl sulfone, tetramethylene sulfone (also known as sulfolane), ethyl methyl sulfone and isopropyl methyl sulfone; nitrile derivatives comprising succinonitrile, adiponitrile, glutaronitrile, and 4,4,4-trifluoronitrile; lithium nitrate (LiNO₃); boron derivatives salt comprising lithium difluoro oxalato borate (LiDFOB) and lithium fluoromalonato (difluoro)borate (LiFMDFB); vinyl acetate, biphenyl benzene, isopropyl benzene, hexafluorobenzene, tris(trimethylsilyl)phosphate, triphenyl phosphine, ethyl diphenylphosphinite, triethyl phosphite, tris(2,2,2-trifluoroethyl) phosphite, maleic anhydride, vinylene carbonate, vinyl ethylene carbonate, mono-fluorinated ethylene carbonate (4-fluoro-1,3-dioxolan-2-one), difluorinated ethylene carbonate, cesium bis(trifluorosulfonyl)imide (CsTFSI) and cesium fluoride (CsF), and mixtures thereof.

In another embodiment, e) the film-forming additive according to the present invention is selected from the group consisting of 1,3-propanesultone (PS), ethylene sulfite (ES), prop-1-ene-1,3-sultone (PES), dimethyl sulfone, tetramethylene sulfone (aka sulfolane), ethyl methyl sulfone, isopropyl methyl sulfone, succinonitrile, adiponitrile, glutaronitrile, 4,4,4-trifluoronitrile, vinyl acetate, biphenyl benzene, isopropyl benzene, hexafluorobenzene, tris(trimethylsilyl)phosphate, triphenyl phosphine, ethyl diphenylphosphinite, triethyl phosphite, tris(2,2,2-trifluoroethyl) phosphite, maleic anhydride, vinylene carbonate, vinyl ethylene carbonate, mono-fluorinated ethylene carbonate, difluorinated ethylene carbonate, cesium bis(trifluorosulfonyl)imide (CsTFSI) and cesium fluoride (CsF), and mixtures thereof.

In one preferred embodiment, e) the film-forming additive according to the present invention is vinylene carbonate.

In another preferred embodiment, e) the film-forming additive according to the present invention is lithium nitrate (LiNO₃).

In the other embodiment, e) the film-forming additive according to the present invention is an ionic liquid.

The term “ionic liquid” as used herein refers to a compound comprising a positively charged cation and a negatively charged anion, which is in the liquid state at the temperature of 100° C. or less under atmospheric pressure. While ordinary liquids such as water are predominantly made of electrically neutral molecules, ionic liquids are largely made of ions and short-lived ion pairs. As used herein, the term “ionic liquid” indicates a compound free from solvent.

The term “onium cation” as used herein refers to a positively charged ion having at least part of its charge localized on at least one non-metal atom such as O, N, S, or P.

In the present invention, the ionic liquid has a general formula of Aⁿ⁻Q^{l+}_{(n/l)}, wherein
Aⁿ⁻ represents an anion;
Q^{l+}_{(n/l)} represents a cation;
n and l, independently selected between 1 and 5, represent respectively the charges of the anion Aⁿ⁻ and of the cation Q^{l+}_{(n/l)}.

The cation(s) may be selected, independently of one another, from metal cations and organic cations. The cation(s) may be mono-charged cations or polycharged cations.

As metal cation, mention may preferably be made of alkali metal cations, alkaline-earth metal cations and cations of d-block elements.

In the present invention, Q^{l+}_{(n/l)} may represent an onium cation. Onium cations are cations formed by the elements of Groups VB and VIB (as defined by the old European IUPAC system according to the Periodic Table of the Elements) with three or four hydrocarbon chains. The Group VB comprises the N, P, As, Sb and Bi atoms. The Group VIB comprises the O, S, Se, Te and Po atoms. The onium cation can in particular be a cation formed by an atom selected from the group consisting of N, P, O and S, more preferably N and P, with three or four hydrocarbon chains.

The onium cation Q^{l+}_{(n/l)} can be selected from:
heterocyclic onium cations; in particular those selected from the group consisting of:

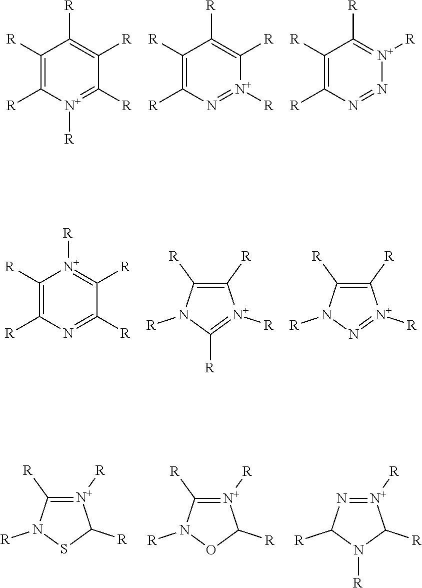

unsaturated cyclic onium cations; in particular those selected from the group consisting of:

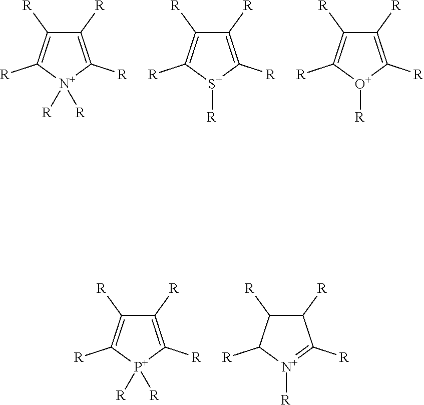

saturated cyclic onium cations; in particular those selected from the group consisting of:

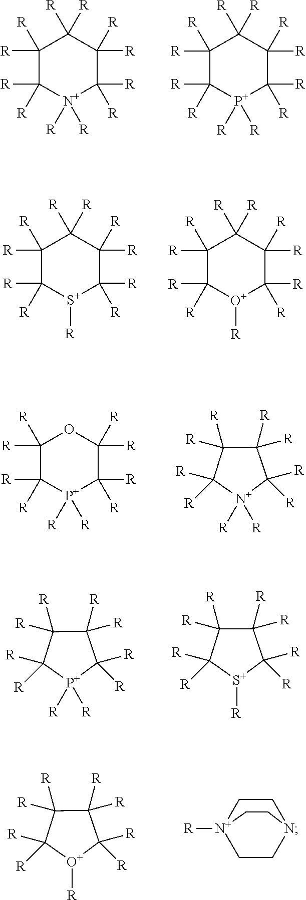

and
non-cyclic onium cations; in particular those of general formula ⁺L-R′ₛ, in which L represents an atom selected from the group consisting of N, P, O and S, more preferably N and P, s represents the number of R′ groups selected from 2, 3 or 4 according to the valence of the element L, each R′ independently represents a hydrogen atom or a C₁ to C₈ alkyl group, and the bond between L⁺ and R′ can be a single bond or a double bond.

In the above formulas, each “R” symbol represents, independently of one another, a hydrogen atom or an organic group. Preferably, each “R” symbol can represent, in the above formulas, independently of one another, a hydrogen atom or a saturated or unsaturated and linear, branched or cyclic C₁ to C₁₈ hydrocarbon group optionally substituted one or more times by a halogen atom, an amino group, an imino group, an amide group, an ether group, an ester group, a hydroxyl group, a carboxyl group, a carbamoyl group, a cyano group, a sulfone group or a sulfite group.

The cation Q^{l+}_{(n/l)} can more particularly be selected from ammonium, phosphonium, pyridinium, pyrrolidinium, pyrazolinium, imidazolium, arsenium, quaternary phosphonium and quaternary ammonium cations.

The quaternary phosphonium or quaternary ammonium cations can more preferably be selected from tetraalkylammonium or tetraalkylphosphonium cations, trialkylbenzylammonium or trialkylbenzylphosphonium cations or tetraarylammonium or tetraarylphosphonium cations, the alkyl groups of which, either identical or different, represents a linear or branched alkyl chain having from 4 to 12 carbon atoms, preferably from 4 to 6 carbon atoms, and the aryl groups of which, either identical or different, represents a phenyl or naphthyl group.

In a specific embodiment, Q^{l+}_{(n/l)} represents a quaternary phosphonium or quaternary ammonium cation.

In one preferred embodiment, Q^{l+}_{(n/l)} represents a quaternary phosphonium cation.

Non-limiting examples of the quaternary phosphonium cation comprise trihexyl(tetradecyl)phosphonium, and a tetraalkylphosphonium cation, particularly the tetrabutylphosphonium (PBu₄) cation.

In another embodiment, Q^{l+}_{(n/l)} represents an imidazolium cation. Non-limiting examples of the imidazolium cation comprise 1,3-dimethylimidazolium, 1-(4-sulfobutyl)-3-methyl imidazolium, 1-allyl-3H-imidazolium, 1-butyl-3-methylimidazolium, 1-ethyl-3-methylimidazolium, 1-hexyl-3-methylimidazolium, 1-octyl-3-methylimidazolium

In another embodiment, Q^{l+}_{(n/l)} represents a quaternary ammonium cation which is selected in particular from the group consisting of tetraethylammonium, tetrapropylammonium, tetrabutylammonium, trimethylbenzylammonium, methyltributylammonium, N,N-diethyl-N-methyl-N-(2-methoxyethyl) ammonium, N,N-dimethyl-N-ethyl-N-(3-methoxypropyl) ammonium, N,N-dimethyl-N-ethyl-N-benzyl ammonium, N, N-dimethyl-N-ethyl-N-phenylethyl ammonium, N-tributyl-N-methyl ammonium, N-trimethyl-N-butyl ammonium, N-trimethyl-N-hexyl ammonium, N-trimethyl-N-propyl ammonium, and Aliquat 336 (mixture of methyltri(C₈ to C₁₀ alkyl)ammonium compounds).

In one embodiment, Q^{l+}_{(n/l)} represents a piperidinium cation, in particular N-butyl-N-methyl piperidinium, N-propyl-N-methyl piperidinium.

In another embodiment, Q^{l+}_{(n/l)} represents a pyridinium cation, in particular N-methylpyridinium.

In a more preferred embodiment, Q^{l+}_{(n/l)} represents a pyrrolidinium cation. Among specific pyrrolidinium cations, mention may be made of the following: C₁₋₁₂alkyl-C₁₋₁₂alkyl-pyrrolidinium, and more preferably C₁₋₄alkyl-C₁₋₄alkyl-pyrrolidinium. Examples of pyrrolidinium cations comprise, but not limited to, N,N-dimethylpyrrolidinium, N-ethyl-N-methylpyrrolidinium, N-isopropyl-N-methylpyrrolidinium, N-methyl-N-propylpyrrolidinium, N-butyl-N-methylpyrrolidinium, N-octyl-N-methylpyrrolidinium, N-benzyl-N-methylpyrrolidinium, N-cyclohexylmethyl-N-methylpyrrolidinium, N-[(2-hydroxy)ethyl]-N-methylpyrrolidinium. More preferred are N-methyl-N-propylpyrrolidinium (PYR13) and N-butyl-N-methylpyrrolidinium (PYR14).

Non-limiting examples of an anion of the ionic liquid comprise iodide, bromide, chloride, hydrogen sulfate, dicyanamide, acetate, diethyl phosphate, methyl phosphonate, fluorinated anion, e.g. hexafluorophosphate (PF₆⁻) and tetrafluoroborate (BF₄⁻), and oxalatooborate of the following formula:

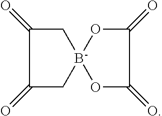 [SMILES: O=C1C[B-]2(CC1=O)OC(=O)C(=O)O2]

In one embodiment, Aⁿ⁻ is a fluorinated anion. Among the fluorinated anions that can be used in the present invention, fluorinated sulfonimide anions may be particularly advantageous. The organic anion may, in particular, be selected from the anions having the following general formula:

(Eₐ-SO₂)N⁻R
in which:
   Eₐ represents a fluorine atom or a group having preferably from 1 to 10 carbon atoms, selected from fluoroalkyls, perfluoroalkyls and fluoroalkenyls, and
   R represents a substituent.

Preferably, Eₐ may represent F or CF₃.

According to a first embodiment, R represents a hydrogen atom.

According to a second embodiment, R represents a linear or branched, cyclic or non-cyclic hydrocarbon-based group, preferably having from 1 to 10 carbon atoms, which can optionally bear one or more unsaturations, and which is optionally substituted one or more times with a halogen atom, a nitrile function, or an alkyl group optionally substituted one of several times by a halogen atom. Moreover, R may represent a nitrile group —CN.

According to a third embodiment, R represents a sulfinate group. In particular, R may represent the group —SO₂-Eₐ, Eₐ being as defined above. In this case, the fluorinated anion may be symmetrical, i.e. such that the two Eₐ groups of the anion are identical, or non-symmetrical, i.e. such that the two Eₐ groups of the anion are different.

Moreover, R may represent the group —SO₂—R′, R′ representing a linear or branched, cyclic or non-cyclic hydrocarbon-based group, preferably having from 1 to 10 carbon atoms, which can optionally bear one or more unsaturations, and which is optionally substituted one or more times with a halogen atom, a nitrile function, or an alkyl group optionally substituted one of several times by a halogen atom. In particular, R′ may comprise a vinyl or allyl group. Furthermore, R may represent the group —SO₂—N—R′, R′ being as defined above or else R′ represents a sulfonate function —SO₃.

Cyclic hydrocarbon-based groups may preferably refer to a cycloalkyl group or to an aryl group. “Cycloalkyl” refers to a monocyclic hydrocarbon chain, having 3 to 8 carbon atoms. Preferred examples of cycloalkyl groups are cyclopentyl and cyclohexyl. “Aryl” refers to a monocyclic or polycyclic aromatic hydrocarbon group, having 6 to 20 carbon atoms. Preferred examples of aryl groups are phenyl and naphthyl. When a group is a polycyclic group, the rings may be condensed or attached by a (sigma) bonds.

According to a fourth embodiment, R represents a carbonyl group. R may, in particular, be represented by the formula —CO—R′, R′ being as defined above.

The organic anion that can be used in the present invention may advantageously be selected from the group consisting of CF₃SO₂N⁻SO₂CF₃ (bis(trifluoromethane sulfonyl)imide anion, commonly denoted as TFSI), FSO₂N⁻SO₂F (bis(fluorosulfonyl)imide anion, commonly denoted as FSI), CF₃SO₂N⁻SO₂F, and CF₃SO₂N⁻SO₂N—SO₂CF₃.

In a preferred embodiment, the ionic liquid contains:
a positively charged cation selected from the group consisting of imidazolnium, pyridinium, pyrrolidinium and piperidinium ions optionally containing one or more C₁-C₃₀ alkyl groups, and
a negatively charged anion selected from the group consisting of halides, fluorinated anions, and borates.

Non-limiting examples of C₁-C₃₀ alkyl groups include, notably, methyl, ethyl, propyl, iso-propyl, n-butyl, isobutyl, sec-butyl, t-butyl, pentyl, isopentyl, 2,2-dimethyl-propyl, hexyl, 2,3-dimethyl-2-butyl, heptyl, 2,2-dimethyl-3-pentyl, 2-methyl-2-hexyl, octyl, 4-methyl-3-heptyl, nonyl, decyl, undecyl and dodecyl groups.

In one preferred embodiment, e) the film-forming additive according to the present invention is selected from the group consisting of N-methyl-N-propylpyrrolidinium bis(fluorosulfonyl) imide (PYR13FSI), N-butyl-N-methylpyrrolidinium bis(fluorosulfonyl) imide (PYR14FSI), N-methyl-N-propylpyrrolidinium bis(trifluoromethanesulfonyl) imide (PYR13TFSI), and N-butyl-N-methylpyrrolidinium bis(trifluoromethanesulfonyl) imide (PYR14TFSI).

In the present invention, the total amount of e) the film-forming additive may be from 0 to 30 wt %, preferably from 0 to 20 wt %, more preferably from 0 to 15 wt %, and even more preferably from 0 to 5 wt % with respect to the total weight of the liquid electrolyte.

The total amount of e) the film-forming additive, if contained in the liquid electrolyte of the present invention, is from 0.05 to 10.0 wt %, preferably from 0.05 to 5.0 wt %, and more preferably from 0.05 to 2.0 wt % with respect to the total weight of the liquid electrolyte.

In a preferred embodiment, the total amount of e) the film-forming additive accounts for at least 1.0 wt % of the liquid electrolyte.

The present invention also provides a lithium metal battery comprising:
an anode comprising lithium metal;
a cathode;
a separator; and
a liquid electrolyte according to the present invention.

In the present invention, the term “anode” is intended to denote, in particular, the electrode of an electrochemical cell, where oxidation occurs during discharging.

In the present invention, the term “cathode” is intended to denote, in particular, the electrode of an electrochemical cell, where reduction occurs during discharging.

In the present invention, the nature of the “current collector” depends on whether the electrode thereby provided is either a cathode or anode. Should the electrode of the invention be a cathode, the current collector typically comprises, preferably consists of at least one metal selected from the group consisting of Aluminium (Al), Nickel (Ni), Titanium (Ti), and alloys thereof, preferably Al. Should the electrode of the invention be an anode, the current collector typically comprises, preferably consists of at least one metal selected from the group consisting of Lithium (Li), Sodium (Na), Zinc (Zn), Magnesium (Mg), Copper (Cu) and alloys thereof, preferably Cu.

In the present invention, the term “electro-active material” is intended to denote an electro-active material that is able to incorporate or insert into its structure and substantially release therefrom lithium ions during the charging phase and the discharging phase of a battery.

In the case of forming a cathode for a lithium metal battery, the cathode electro-active material is not particularly limited. It may comprise a composite metal chalcogenide of formula LiMQ₂, wherein M is at least one metal selected from transition metals such as Co, Ni, Fe, Mn, Cr, and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0<x<1), and spinel-structured LiMn₂O₄.

Another preferred examples thereof may include lithium-nickel-manganese-cobalt-based metal oxide of formula LiNiₓMn_{y}Co_{z}O₂ (x+y+z=1, referred to as NMC), for instance LiNi_{1/3}Mn_{1/3}Co₁₃O₂, LiNi_{0.6}Mn_{0.2}Co_{0.2}O₂, lithium-nickel-cobalt-aluminum-based metal oxide of formula LiNiₓCo_{y}Al_{z}O₂ (x+y+z=1, referred to as NCA), for instance LiNi_{0.8}Co_{0.15}Al_{0.05}O₂, lithium-cobalt-based metal oxide, or lithium-nickel-manganese-based metal oxide (LNMO) as a cathode electroactive material.

As an alternative, still in the case of forming a cathode for a lithium metal battery, the cathode electro-active compound may comprise a lithiated or partially lithiated transition metal oxyanion-based electro-active material of formula M₁M₂(JO₄)_{f}E_{1-f}, wherein M₁ is lithium, which may be partially substituted by another alkali metal representing less that 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electro-active material as defined above is preferably phosphate-based and may have an ordered or modified olivine structure.

More preferably, the cathode electro-active material has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the electro-active material is a phosphate-based electro-active material of formula Li(FeₓMn₁₋ₓ)PO₄ wherein Ox 1, wherein x is preferably 1 (that is to say, lithium iron phosphate of formula LiFePO₄).

In a preferred embodiment, the cathode electro-active material is selected from the group consisting of LiMQ₂, wherein M is at least one metal selected from Co, Ni, Fe, Mn, Cr and V and Q is O or S; LiNiₓCo₁₋ₓO₂ (0<x<1); spinel-structured LiMn₂O₄; lithium-nickel-manganese-cobalt-based metal oxide of formula LiNiₓMn_{y}Co_{z}O₂ (x+y+z=1), lithium-nickel-cobalt-aluminum-based metal oxide of formula LiNiₓCo_{y}Al_{z}O₂ (x+y+z=1), and LiFePO₄.

In another preferred embodiment, the cathode comprises lithium-nickel-manganese-cobalt-based metal oxide of formula LiNiₓMn_{y}Co_{z}O₂ (x+y+z=1), lithium-nickel-cobalt-aluminum-based metal oxide of formula LiNiₓCo_{y}Al_{z}O₂ (x+y+z=1), lithium-cobalt-based metal oxide, or lithium-nickel-manganese-based metal oxide (LNMO) as a cathode electro-active material.

In one embodiment, at least one electro-active compound according to the present invention is loaded onto the cathode current collector to have an areal capacity between 1.0 mAh/cm² and 10.0 mAh/cm², preferably between 3.0 mAh/cm² and 8.0 mAh/cm² and more preferably between 4.0 mAh/cm² and 7.0 mAh/cm².

In the present invention, the expression “thickness of the cathode” is intended to denote a total combined thickness of the cathode current collector and the cathode electro-active material layer.

In one embodiment, the thickness of the cathode according to the present invention is between 40 μm and 150 μm, preferably between 50 μm and 120 μm, and more preferably between 60 μm and 100 μm.

By the term “separator”, it is hereby intended to denote a monolayer or multilayer polymeric, nonwoven cellulouse or ceramic material/film, which electrically and physically separates the electrodes of opposite polarities in an electrochemical device and is permeable to ions flowing between them.

In the present invention, the separator can be any porous substrate commonly used for a separator in an electrochemical device.

In one embodiment, the separator is a porous polymeric material comprising at least one material selected from the group consisting of polyester such as polyethylene terephthalate and polybutylene terephthalate, polyphenylene sulphide, polyacetal, polyamide, polycarbonate, polyimide, polyether sulfone, polyphenylene oxide, polyphenylene sulfide, polyethylene naphthalene, polyethylene oxide, polyacrylonitrile, polyolefin such as polyethylene and polypropylene, or mixtures thereof.

In a particular embodiment, the separator is a porous polymeric material coated with inorganic nanoparticles, for instance, SiO₂, TiO₂, Al₂O₃, ZrO₂, etc.

In another particular embodiment, the separator is a porous polymeric material coated with polyvinylidene difluoride (PVDF).

Should the disclosure of any patents, patent applications, and publications which are incorporated herein by reference conflict with the description of the present application to the extent that it may render a term unclear, the present description shall take precedence.

The invention will be now explained in more detail with reference to the following examples, whose purpose is merely illustrative and not intended to limit the scope of the invention.

### Examples

### Raw Materials

Fluorinated di-ethers:
   C₆F₈H₆O₂(CF₂HCF₂—OCH₂CH₂O—CF₂CF₂H) with bp of 160° C., synthesized within Solvay (BP160 hereinafter)
   C₆F₁₁H₃O₂ having a boiling point of about 100° C., synthesized within Solvay (BP100 hereinafter)
Fluorinated monoether:
   1,1,2,2-tetrafluoroethyl-2,2,2-trifluoroethyl ether (CF₃CH₂OCF₂CF₂H) synthesized within Solvay (HFE-347 hereinafter)
Non-fluorinated ether:
   1,2-dimethoxyethane (DME), commercially available from Enchem
Li salt:
   lithium bis(fluorosulfonyl)imide (LiFSI), commercially available from Nippon Shokubai
LiPF₆: commercially available from Enchem

### A/ Formulations of the Liquid Electrolyte:

The liquid electrolytes were prepared for the Inventive Example of E1 and Comparative Examples of CE1-CE3 Their constituents are summarized in Table 1 below:

TABLE 1

| | non-fluourinated ether/ | | LiPF₆ |
|---|---|---|---|
| Examples | fluorinated (mono- or di-)ether | Li Salt | (wt %)* |
| E1 | DME/BP160 (20/80)* (91.94)** | 1M LiFSI | 1.0 |
| | | (8.06)** | |
| E2 | DME/BP100 (20/80)* (91.94)** | 1M LiFSI | 1.0 |
| | | (8.06)** | |
| CE1 | DME/BP160 (20/80)* (91.94)** | 1M LiFSI | — |
| | | (8.06)** | |
| CE2 | DME (100)* (91.94)** | 1M LiFSI | 1.0 |
| | | (8.06)** | |
| CE3 | DME (100)* (91.94)** | 1M LiFSI | — |
| | | (8.06)** | |
| CE4 | DME/BP100 (20/80)* (91.94)** | 1M LiFSI | — |
| | | (8.06)** | |
| CE5 | DME/HFE-347 (20/80)* (91.94)** | 1M LiFSI | — |
| | | (8.06)** | |
| CE6 | DME/HFE-347 (20/80)* (91.94)** | 1M LiFSI | 1.0 |
| | | (8.06)** | |

*vol % with respect to the total volume of fluorinated mono- or di-ether and non-fluorinated ether
**vol % with respect to the total volume of the liquid electrolyte
***wt % with respect to the total weight of the liquid electrolyte

When preparing the liquid electrolyte of E1, 1M LiFSI was first dissolved in 20 vol % of DME with respect to the total volume of DME and BP160 and was mixed using a magnetic stirrer within a glove box. After the solution became transparent, 80 vol % of BP160 was added to the solution with respect to the total volume of DME and BP160. 1 wt % of LiPF₆ (with respect to the total weight of the liquid electrolyte) was subsequently added to the solution.

The liquid electrolyte of E2 was prepared in the same manner as E1, except that BP100 was used instead of BP160.

The liquid electrolyte of CE1 was prepared in the same manner as E1, except that LiPF₆ was not added.

When preparing the liquid electrolyte of CE2, 1M LiFSI was first dissolved in DME and was mixed using a magnetic stirrer within a glove box. 1 wt % of LiPF₆ (with respect to the total weight of the liquid electrolyte) was subsequently added to the solution.

The liquid electrolyte of CE3 was prepared in the same manner as CE2, except that LiPF₆ was not added.

The liquid electrolyte of CE4 was prepared in the same manner as E2, except that LiPF₆ was not added.

The liquid electrolyte of CE5 was prepared in the same manner as CE4, except that HFE-347 was added instead of BP100.

The liquid electrolyte of CE6 was prepared in the same manner as CE5, except that 1 wt % of LiPF₆ was added with respect to the total weight of the liquid electrolyte.

### B/ Preparation of the Lithium Metal Cells:

LiCoO₂, a conducting agent Super-P (commercially available from LiFUN Technology), polyvinylidene fluoride (PVDF), and N-methyl-2-pyrrolidone (NMP) were mixed to obtain a cathode composition. The cathode composition included LiCoO₂, a conducting agent, and PVDF having a weight ratio of about 97.8:1.2:1.0.

The cathode composition was coated on the top surface of an aluminum foil with a thickness of about 20 μm, and then thermal treatment was applied under vacuum at about 110° C., so as to obtain the cathode.

A polyethylene separator (commercially available from Tonen Corporation) was disposed between the cathode obtained according to the above-described process and a lithium metal as the anode (commercially available from Honjo Metal Ltd.) with a thickness of about 20 μm, thereby preparing a lithium metal battery as coin cell (CR2032 type).

### C/ Activation of Cells and Measurement of Initial Cell Performance

1—Formation (Activation of lithium metal cells): After the manufacturing of the coin cells, the cells were stored at 25° C. for 10 hours (Aging process). Then the cells were charged to 4.4V and discharged to 3.0V repeatedly for 3 cycles to activate the cells.
2—Measurement of cycling performance: The cycling ability of each coin cell was evaluated. Then, each cell was subjected to a repetition of cycles of charge and discharge. One cycle consisted of a charging phase at a charging current of C followed by a discharge phase at a discharge current of C.

### D/ Performance Measurement of the Lithium Metal Cells

The coin cells were tested at various conditions as detailed below:
1-Capacity check for 2 cycles
   Charging: 0.1C/4.4V/0.05C at constant current and constant voltage (CC-CV)
   Discharging: 0.1C/3.0V (CC)
2-Continuous cycling test (up to 300 cycles)
   Charging: 0.5C/4.4V/0.05C (CC-CV)
   Discharging: 0.5C/3.0V (CC)

### E/ Cycle Tests—Capacity Retention:

The cycling ability of each cell was evaluated and then each cell was subjected to a repetition of cycles of charge and discharge. One cycle consisted of a charging phase at a charging current of C followed by a discharge phase at a discharge current of C. The following results were obtained as shown in Table 2 below:

TABLE 2

| | Number of cycles |
|---|---|
| Examples | at 80% of capacity retention |
| E1 | 230 |
| E2 | 150 |
| CE1 | 165 |
| CE2 | 23 |
| CE3 | 24 |
| CE4 | 130 |
| CE5 | 105 |
| CE6 | 100 |

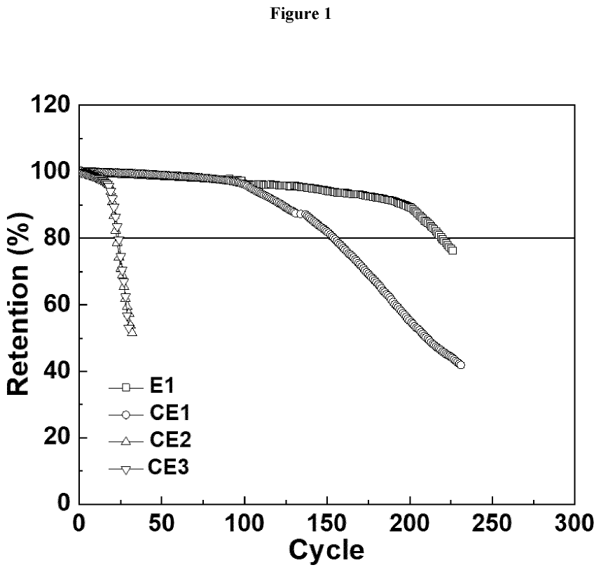

FIG. 1 shows the variation of the capacity retention of E1 and CE1-CE3 as a function of the cycle number.

Notably, it was observed that the discharge capacity of E1 according to the present invention, decreased slowly as the number of cycles increased. In particular, FIG. 1 clearly shows that the number of cycles at 80% of capacity retention for Inventive Example of E1, comprising the liquid electrolyte according to the invention, was much higher than those for Comparative Examples, i.e. CE1-CE3. The difference in the number of cycles at 80% of capacity retention of E2 and CE4 clearly shows that the incorporation of 1 wt % of LiPF₆ in addition to the lithum salt (1M LiFSI) contributes to the improvement of the cycle retention.

In case a fluorinated mono-ether was incorporated instead of a fluorinated di-ether (CE5 and CE6), the number of cycles at 80% of capacity retention decreased regardless of the presence of 1 wt % of LiPF₆, which was much inferior to that of CE1 or CE4 with a fluorinated di-ether (BP160 or BP100), but in the absence of LiPF₆.

1. A liquid electrolyte for lithium metal batteries, comprising:
a) at least one fluorinated di-ether containing from 4 to 10 carbon atoms, represented by Formula I
R¹—O—R²—O—R³ (Formula I)
wherein each R¹ and R³ is independently a fluorinated alkyl group, and R² is an optionally fluorinated alkyl group;
b) at least one non-fluorinated ether;
c) at least one lithium salt; and
d) a lithium hexafluorophosphate (LiPF₆) in an amount of 5% by weight (wt %) or less, based on a total weight of the liquid electrolyte,
wherein a) the fluorinated di-ether is in an amount of at least 50% by volume (vol %), based on a total volume of a) the fluorinated di-ether and b) the non-fluorinated ether; and c) at least one lithium salt is different from d) LiPF₆.

2. The liquid electrolyte for lithium metal batteries according to claim 1, wherein a) the fluorinated di-ether contains from 5 to 8 carbon atoms.

3. The liquid electrolyte for lithium metal batteries according to claim 1, wherein a molar ratio F/H in a) the fluorinated di-ether is from 1.3 to 13.0.

4. The liquid electrolyte for lithium metal batteries according to claim 1, wherein a boiling point of a) the fluorinated di-ether is at least 80.

5. The liquid electrolyte for lithium metal batteries according to claim 1, wherein a) the fluorinated di-ether comprises CF₂HCF₂—O—CH₂CH₂—O—CF₂CF₂H, CF₂HCF₂—O—CHFCHF—O—CF₂CF₂H, CF₂HCF₂—O—CF₂CHF—O—CF₂CF₂H, and mixtures thereof.

6. The liquid electrolyte for lithium metal batteries according to claim wherein b) the non-fluorinated ether comprises dimethoxyethane (DME), 1,3-dioxolane (DOL), dibutylether, tetraethyleneglycol dimethyl ether (TEGME), diethyleneglycol dimethylether (DEGDME), diethyleneglycol diethylether (DEGDEE), polyethyleneglycol dimethylether (PEGDME), 2-methyltetrahydrofuran, tetrahydrofuran (THF), triethylphosphate (TEP), and mixtures thereof.

7. The liquid electrolyte for lithium metal batteries according to claim 1, comprising from 60 to 90 vol % of a) the fluorinated di-ether and from 10 to 40 vol % of b) the non-fluorinated ether, based on the total volume of a) the fluorinated di-ether and b) the non-fluorinated ether.

8. The liquid electrolyte for lithium metal batteries according to claim 7, comprising from 80 to 90 vol % of a) the fluorinated di-ether and from 10 to 20 vol % of b) the non-fluorinated ether, based on the total volume of a) the fluorinated di-ether and b) the non-fluorinated ether.

9. The liquid electrolyte for lithium metal batteries according to claim 1, wherein c) the lithium salt is selected from the group consisting of lithium perchlorate (LiClO₄), lithium hexafluoroarsenate (LiAsF₆), lithium hexafluoroantimonate (LiSbF₆), lithium hexafluorotantalate (LiTaF₆), lithium tetrachloroaluminate (LiAlCl₄), lithium tetrafluoroborate (LiBF₄), lithium chloroborate (Li₂B₁₀Cl₁₀), lithium fluoroborate (Li₂B₁₀F₁₀), Li₂B₁₂FₓH₁₂₋ₓ wherein x=0-12, LiPFₓ(R_{F})₆₋ₓ and LiBF_{y}(R_{F})_{4-y} wherein R_{F} represents perfluorinated C₁-C₂₀ alkyl groups or perfluorinated aromatic groups, x=0-5 and y=0-3, lithium trifluoromethane sulfonate (LiCF₃SO₃), lithium bis(fluorosulfonyl)imide Li(FSO₂)₂N (LiFSI), LiN(SO₂CₘF₂ₘ₊₁)(SO₂CₙF₂ₙ₊₁) and LiC(SO₂CₖF₂ₖ₊₁)(SO₂CₘF₂ₘ₊₁)(SO₂CₙF₂₊₁) wherein k=1-10, m=1-10 and n=1-10, LiN(SO₂CₚF₂ₚSO₂) and LiC(SO₂CₚF₂ₚSO₂)(SO₂CF_{2q+1}) wherein p=1-10 and q=1-10, and mixtures thereof.

10. The liquid electrolyte for lithium metal batteries according to claim 1, wherein a concentration of c) the lithium salt is from 0.5 M to 8 M.

11. The liquid electrolyte for lithium metal batteries according to claim 1, further comprising e) at least one film-forming additive in an amount of from 0.05 to 5.0 wt % with respect to the total weight of the liquid electrolyte, wherein e) the film-forming additive is different from c) the lithium salt and from d) LiPF₆.

12. The liquid electrolyte for lithium metal batteries according to claim 11, wherein e) the film-forming additive is selected from the group consisting of cyclic sulphite and sulfate compounds comprising 1,3-propanesultone (PS), ethylene sulphite (ES) and prop-1-ene-1,3-sultone (PES), sulfone derivatives comprising dimethyl sulfone, tetramethylene sulfone (also known as sulfolane), ethyl methyl sulfone and isopropyl methyl sulfone, nitrile derivatives comprising succinonitrile, adiponitrile, glutaronitrile and 4,4,4-trifluoronitrile, and lithium nitrate (LiNO₃); boron derivatives salt comprising lithium difluoro oxalato borate (LiDFOB), lithium fluoromalonato (difluoro)borate (LiFMDFB), vinyl acetate, biphenyl benzene, isopropyl benzene, hexafluorobenzene, tris(trimethylsilyl)phosphate, triphenyl phosphine, ethyl diphenylphosphinite, triethyl phosphite, tris(2,2,2-trifluoroethyl) phosphite, maleic anhydride, vinylene carbonate, vinyl ethylene carbonate, cesium bis(trifluolorosulfonyl)imide (CsTFSI), cesium hexafluorophosphate (CsPF₆), cesium fluoride (CsF), trimethylboroxine (TMB), tributyl borate (TBB), 2-(2,2,3,3,3-pentafluoropropoxy)-1,3,2-dioxaphospholane (PFPOEPi), 2-(2,2,3,3,3-pentafluoropropoxy)-4-(trifluormethyl)-1,3,2-dioxaphospholane (PFPOEPi-1CF₃), silver nitrate (AgNO₃), silver hexafluorophosphate (AgPF₆), tris(trimethylsilyl)phosphine (TMSP), 1,6-divinylperfluorohexane, and mixtures thereof.

13. A lithium metal battery comprising
an anode comprising lithium metal;
a cathode;
a separator; and
a liquid electrolyte according to claim 1.

14. The lithium metal battery according to claim 13, wherein the cathode comprises lithium-nickel-manganese-cobalt-based metal oxide of formula LiNiₓMn_{y}Co_{z}O₂ (x+y+z=1), lithium-nickel-cobalt-aluminum-based metal oxide of formula LiNiₓCo_{y}Al_{z}O₂ (x+y+z=1), lithium-cobalt-based metal oxide, or lithium-nickel-manganese-based metal oxide (LNMO) as a cathode electro-active material.

15. The lithium metal battery according to claim 13, wherein the separator is a porous polymeric material comprising at least one material selected from the group consisting of polyethylene terephthalate, polybutylene terephthalate, polyphenylene sulphide, polyacetal, polyamide, polycar bonate, polyimide, polyether sulfone, polyphenylene oxide, polyphenylene sulfide, polyethylene naphthalene, polyethylene oxide, polyacrylonitrile, polyethylene, polypropylene, and mixtures thereof, optionally coated with inorganic nanoparticles.

16. The liquid electrolyte for lithium metal batteries according to claim 1, wherein the lithium hexafluorophosphate (LiPF₆) is in an amount of 3% by weight (wt %) or less, based on the total weight of the liquid electrolyte.

17. The liquid electrolyte for lithium metal batteries according to claim 3, wherein the molar ratio F/H in a) the fluorinated di-ether is from 2.5 to 6.0.

18. The liquid electrolyte for lithium metal batteries according to claim 9, wherein c) the lithium salt is LiFSI.

19. The liquid electrolyte for lithium metal batteries according to claim 10, wherein the concentration of c) the lithium salt is from 0.7 M to 4 M.

20. The liquid electrolyte for lithium metal batteries according to claim 11, wherein the at least one film-forming additive e) is in an amount of from 0.05 to 3.0 wt % with respect to the total weight of the liquid electrolyte.
